(19) United States
(12) Patent Application Publication
(10) Pub. No.: US 2008/0286479 A1
(43) Pub. Date: Nov. 20, 2008

(54) METHOD OF COATING LEAD FRAMES

(75) Inventors: Manuel Brand, Feldkirch (AT); Gerhard Peter, Sulz (AT)

Correspondence Address: K.F. ROSS P.C., 5683 RIVERDALE AVENUE, SUITE 203 BOX 900, BRONX, NY, 10471-0900, US

(73) Assignee: Hirschmann Automotive GmbH

(21) Appl. No.: 12/038,164

(22) Filed: Feb. 27, 2008

(30) Foreign Application Priority Data
Feb. 28, 2007 (DE) 102007009671.4

(51) Int. Cl. B05D 1/02

(52) U.S. Cl. 427/421.1; 427/430.1

(57) ABSTRACT

The invention relates to a method of coating multiple lead frames that are connected to mechanical, electrical, or electronic components, with the lead frames encased in a coating composed of plastic, with provision being made according to the invention for the coating to be applied without a mold tool surrounding the lead frame.

The invention relates to a method of coating lead frames according to the features of the generic portion of claim 1.

EP 0 891 124 A2 discloses multiple lead frames that are connected using mechanical, electrical, or electronic components, with the lead frames encased in a coating made of plastic. Here, the connection points to the components are bare, while the remaining areas of the lead frames are encased in the plastic coating.

Moreover, it is known that a lead frame, fitted with electrical and mechanical components, must be encased in an insulating material and the individual segments must be connected to one another. After the connections have been made, the lead frame is stamped free of is connections. Here, it is known that electrical, electronic, and/or mechanical components are fitted on the lead frame, then they are contacted in an electrical and mechanical fashion, and subsequently extrusion coated or encapsulated. After this process, it is necessary for the pieces to be stamped free. The extrusion coating or encapsulation occurs in corresponding molds (tools) such that the disadvantage exists that the costs for the molds (tools) are high and this known method is not appropriate for small quantities. Moreover, it may be disadvantageous that, during extrusion coating with plastic at a very high temperature, damage to the components and, in the worst case, a loss of function may occur.

The object of the invention is therefore to prevent the disadvantages described above. In particular, the object is to provide a method of coating multiple lead frames by means of which costs are reduced and small quantities may be processed. In the best case, the strain on the components due to outside influences, such as in particular very high temperatures, should also be reduced.

This object is attained by the features of claim 1.

Provision is made according to the invention for the coating to be applied without a molding tool around the lead frame. In further embodiments of the invention, the application of the plastic occurs, for example, by screen printing, stencil printing, dispensing, preferably jet dispensing, or by dipping the lead frame that has been fitted with components into the liquid plastic, waiting until the liquid plastic has hardened. This manner in which the plastic is applied to the lead frame with the mounted components has the advantage that a mold tool may be omitted, which reduces costs considerably as compared to a method in which the multiple lead frames are placed in one mold and cast with plastic. Because there is no mold tool, the method according to the invention lends itself in an advantageous fashion to use with smaller quantities as well. Another significant advantage of the invention is that the coating is applied using a method in which the plastic is at a lower temperature compared to the known injection-molding methods such that the strain on the components is considerably lower.

In the method according to the invention, therefore, the necessary components are soldered to the lead frame at the desired points, glued by an electrically conductive adhesive or the like (such as welding, for example), the part that has been prepared in this manner being subsequently encased in the plastic.

The components may be mechanical components such as, for example, snap-fits, mounting plates, or the like. If the components are electrical components, they either have only an electrical functional (such as, for example, a wire jumper) or connect an electrical function with a mechanical function (such as, for example, plug contacts). Alternately or additionally, it is also conceivable for the components to be electronic components (such as, for example, resistors, capacitors, inductors, integrated circuits, basics, or the like).

By screen printing, stencil printing, printing (in particular jet printing), or dipping (the use of other methods is conceivable as well; this list is not exclusive), with an adhesive, a liquid and/or hot plastic, or a plastic powder, the lead frame is partially or completely surrounded at the desired points. However, the coating of the lead frame may occur before or after installation on the components.

This method according to the invention has the advantage that three functions are connected to one another (coating and connecting the lead frame as well as protecting the components) and are thus united in one process. Therefore, no mold tool is necessary, costs are considerably reduced, the strain on the components as a result of higher temperatures is reduced, and process security is increased. Finally, small quantities may also be produced in an economical fashion using the method according to the invention.

In a further development of the invention, an electrically conductive connector mass (such as, for example, a soldering paste, a conductive adhesive, or the like) is applied at the points at which a component is to come into contact with the lead frame, the component is attached, and subsequently the coating (for example, a protective plastic having an adhesive or a powder) is applied. This entire component group is heated (for example, in an oven) such that the components involved are heated to the required temperature. Here, it is important for this required temperature, on the one hand, to be below the temperatures that are necessary for conventional plastic injection molding processes with mold tools and, on the other hand, the temperature is at a level to allow surface melting of the electrically conductive connector mass so as to connect the connection points of the component to the connection points of the lead frame in a non-detachable fashion. The plastic used cures simultaneously with the surface melting of the electrically conductive connector mass, such that the assembled lead frame is finished when cooled. If a conductive adhesive is used as an electrically conductive connector mass, the additional advantage results that it cures simultaneously with the curing of the surrounding plastic.

As an alternative to heating the elements involved, it is also conceivable, for example, for a hot and liquid plastic to be applied that, at the same time, causes the soldering metal or soldering paste to melt and/or allows hot curing of the conductive adhesive.

Thus, the overall advantage results that one process is possible for two different methods.

Illustrated embodiments of the performance of the method according to the invention that leads to lead frames are described below with reference to the drawings. Therein:

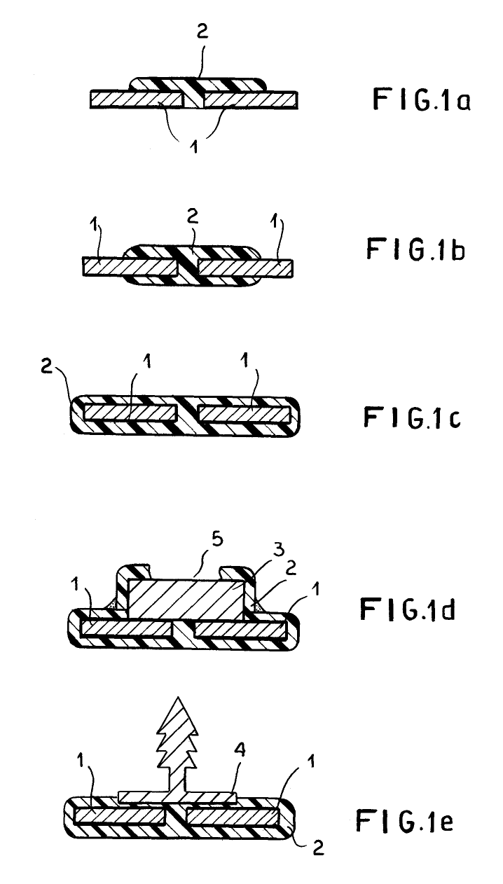

FIGS. 1a to 1e show various embodiments of a single-layer lead frame;

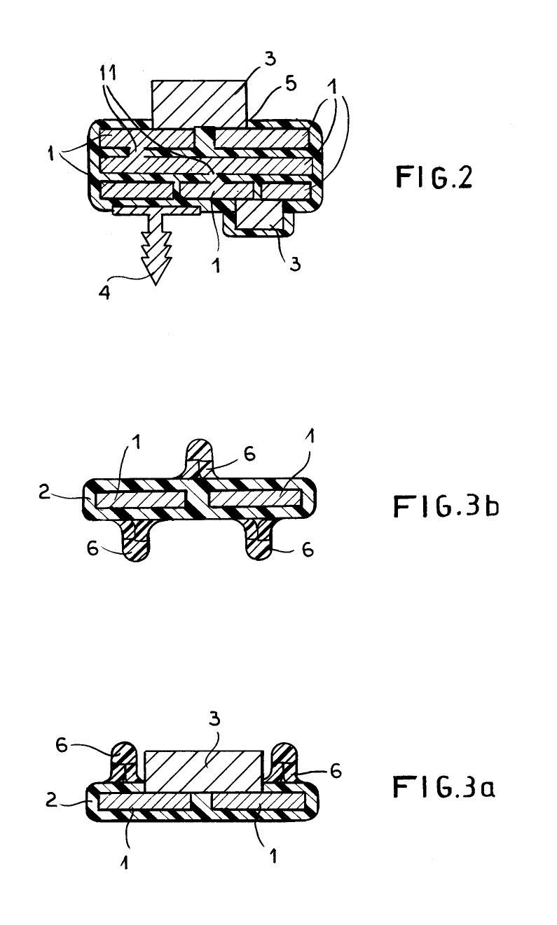

FIG. 2 shows a lead frame with multiple layers;

FIGS. 3a and 3b show a lead frame with reinforcements and/or a protective frame.

To the extent that it is shown in detail, the reference character 1 is used in FIGS. 1 to 3 to indicate a lead frame that is encased in a plastic coating 2. In FIG. 1a, it can be seen that two lead frames are arranged adjacent each other and surrounded on one side by the plastic coating 2. FIG. 1b shows a similar embodiment in which the plastic coating 2 surrounds the lead frames 1 on both faces. In contrast, FIG. 1c shows that the lead frames 1 are completely encased in the plastic coating 2. FIG. 1d shows a component 3 (for example, an electronic component such as a capacitor or the like) that is connected electrically to both lead frames 1. The component 3 may be completely encased in the plastic coating 2 (protective function) or an opening 5 may be left (for example, in order to be able to recognize which component is there). FIG. 1e shows a mechanical component 4 such as, for example, a snap prong that is not in contact with the lead frame 1 and is held only by the plastic coating 2. The mechanical component 4 is either surrounded along with the lead frame when the plastic coating 2 is applied and attached in this manner, or it may also be attached after the fact (for example, by adhesion). Thus, FIGS. 1a to 1e show the most simple form of a single-layer lead frame (monolayer), which is often sufficient for the realization of simple electrical or electronic circuits and therefore for limited-lot production.

FIG. 2 shows an illustrated embodiment of a lead frame with multiple layers (multilayer), with multiple lead frames 1 being present that are either connected to or separate from one another. Here as well, electronic components 3 may be present and connected to the corresponding points of a respective lead frame 1. Here, it is conceivable for the electronic component 3 to be partially uncovered or to be completely encased in the plastic coating 2. In the same manner, it is also possible for at least one mechanical component 4 to be present. The electrical connection of the lead frames to one another may be accomplished by corresponding connection methods such as soldering, welding, riveting, anisotropic conductive adhesives, or other connection methods. With such a multilayer, which is shown in FIG. 2 only by way of example, it is possible to make up complicated circuits.

FIG. 3 shows a lead frame 1 with a surrounding plastic coating 2, with a reinforcement 6 being provided on both sides in FIG. 3a. The reinforcement 6 may also be present on only one side of the lead frame. The single- or double-side reinforcement 6 has the advantage that the structure, which is otherwise flat, is reinforced in the longitudinal direction. As is shown in FIG. 3b, the reinforcements 6 may be used not only for reinforcement, but also to create a boundary (frame) along at least two sides of the electronic component 3, in particular on all four sides, in order to be able to do a retrofit attachment of the component 3 and to provide protection for the component 3 from outside influences (such as impact, for example). Such reinforcements 6 may be applied in three-dimensional structures using highly viscous adhesives, for example, as well as by screen printing or stencil printing in multiple layers, but also by means of repeated dispensing or jet-dispensing.

Overall, the invention therefore offers the advantages that no expensive tools are necessary, that quick implementation is provided, that rapid changes are possible, as well as a large variety of variants. In addition, three-dimensional arrangements as well as virtually every form of electronics may be realized. Using the lead frame 1 and the remaining components, it is possible for control signals to be transmitted as well as high load currents.

One further note regarding the term “dispensing:” Dealing with viscous liquids is fundamentally difficult. In industrial applications, these liquids are primarily (initially) liquid (and then curable) plastics, fluxing agents, adhesives, lacquers, and soldering pastes. These liquids are highly viscous and, in addition, frequently also contain solids, for example, in order to make them conductive. Microsystems technology makes particularly high demands because the liquids must be applied (dispensed) during dispensing on tiny (lead frames) and minuscule components with a small drop size (for example, only a few nanoliters) and in a very precise fashion (for example, within a few microns). Although contact methods such as screen printing, stamping, and the dipping of the components do sufficiently meet these demands, contact-free methods, in which the drop completely detaches from the dosing pump (dispensing head), tend to be gentler (particularly in the case of temperature-sensitive components) and more precise and therefore are used according to the invention in Microsystems technology for circuit supports in the form of lead frames. Dispensing heads for highly viscous liquids in particular discharge the liquid from a microjet. Outside of the jet, the liquid constricts by virtue of its surface tension and forms a flying drop with a defined speed. The rest withdraws and wets the dispensing head at high viscosities. The issue of whether the device is still functional depends on the size of this meniscus that is influenced by the surface tension and particularly by the viscosity. These parameters may be controlled via the temperature.

### LIST OF REFERENCE CHARACTERS

1. Lead frame
2. Coating
3. Electronic component
4. Mechanical component
5. Recess
6. Reinforcement
11. Electrical connection

1. A method of surrounding multiple lead frames that are connected to mechanical, electrical, or electronic components, with the lead frames being encased in a coating composed of plastic wherein the coating is applied without a mold tool surrounding the lead frame.

2. The method according to claim 1 wherein the coating is applied using screen printing.

3. The method according to claim 1 wherein the coating is applied using stencil printing.

4. The method according to claim 1 wherein the coating is applied by dispensing, in particular jet dispensing.

5. The method according to claim 1 wherein the coating is applied by dipping in the liquid plastic and a delay occurs until the liquid plastic has hardened.

6. The method according to claim 1 wherein an electrically conductive connector mass is applied at the points at which a component is to come into contact with the lead frame, the component is attached, and subsequently the coating is applied.

7. The method according to claim 6 wherein a heat process is carried out.

8. The method according to claim 7 wherein the heating occurs via the plastic, which was heated to a temperature that may be predetermined.

9. The method according to claim 1 wherein at least one reinforcement is formed from the plastic coating.
